(19) United States
(12) Patent Application Publication
(10) Pub. No.: US 2026/0300222 A1
(43) Pub. Date: Oct. 1, 2026

(54) HIERARCHAL SNAPSHOT RETENTION STORAGE

(71) Applicant: Rubrik, Inc., Palo Alto, CA (US)

(72) Inventors: Harmandeep Singh, Bangalore, Karnataka (IN); Shubham Tagra, Bangalore, Karnataka (IN); Sayantan Jana, Palo Alto, CA (US); Amit Kundlia, Bangalore, Karnataka (IN); Mudit Malpani, Palo Alto, CA (US)

(21) Appl. No.: 19/231,266

(22) Filed: Jun. 6, 2025

(30) Foreign Application Priority Data
Mar. 31, 2025 (IN) 202511031826

(51) Int. Cl. G06F 16/11; G06F 16/16; G06F 16/182

(52) U.S. Cl. CPC G06F 16/128; G06F 16/162; G06F 16/183

(57) ABSTRACT

Methods, systems, and devices for data management are described. A data management system (DMS) may store snapshots at different hierarchal levels in accordance with different snapshot frequencies. For example, the DMS may store one or more sets of first-level snapshots in accordance with a first snapshot frequency and store one or more second-level snapshot in accordance with a second snapshot frequency. The first set of first-level snapshots may depend on a base snapshot. The DMS may store a first second-level snapshot as an incremental snapshot relative to the base snapshot and subsequent first-level snapshots may depend on the first second-level snapshot. When the first set of first-level snapshots expire, the DMS may delete the first set of first-level snapshots. The hierarchal structure of different snapshot frequency levels may expand for any quantity of snapshot frequency.

### CROSS REFERENCE

The present Application for Patent claims the benefit of India Patent Application No. 202511031826 by Singh et al., entitled “HIERARCHAL SNAPSHOT RETENTION STORAGE,” filed Mar. 31, 2025, assigned to the assignee hereof, and expressly incorporated by reference herein.

### FIELD OF TECHNOLOGY

The present disclosure relates generally to data management, including techniques for hierarchal snapshot retention storage.

### BACKGROUND

A data management system (DMS) may be employed to manage data associated with one or more computing systems. The data may be generated, stored, or otherwise used by the one or more computing systems, examples of which may include servers, databases, virtual machines, cloud computing systems, file systems (e.g., network-attached storage (NAS) systems), or other data storage or processing systems. The DMS may provide data backup, data recovery, data classification, or other types of data management services for data of the one or more computing systems. Improved data management may offer improved performance with respect to reliability, speed, efficiency, scalability, security, or ease-of-use, among other possible aspects of performance.

### BRIEF DESCRIPTION OF THE DRAWINGS

FIG. 1 illustrates an example of a computing environment that supports hierarchal snapshot retention storage in accordance with aspects of the present disclosure.

FIG. 2 shows an example of a hierarchal snapshot diagram that supports hierarchal snapshot retention storage in accordance with aspects of the present disclosure.

FIGS. 3-7 show examples of hierarchal snapshot operations that supports hierarchal snapshot retention storage in accordance with aspects of the present disclosure.

FIG. 8 shows a block diagram of an apparatus that supports hierarchal snapshot retention storage in accordance with aspects of the present disclosure.

FIG. 9 shows a block diagram of a snapshot manager that supports hierarchal snapshot retention storage in accordance with aspects of the present disclosure.

FIG. 10 shows a diagram of a system including a device that supports hierarchal snapshot retention storage in accordance with aspects of the present disclosure.

FIG. 11 shows a flowchart illustrating methods that support hierarchal snapshot retention storage in accordance with aspects of the present disclosure.

### DETAILED DESCRIPTION

Some backup and recovery systems may use snapshot chains, where snapshots of a target computing system are stored as chains that include a base (e.g., full) snapshot along with one or more incremental snapshots, with each incremental snapshot reflecting the changes to the target computing system since a time corresponding to a prior snapshot in the chain. Snapshots may expire (e.g., no longer be required to be retained) over time in accordance with a retention policy. As snapshots expire, they may not immediately be garbage collected because other snapshots (e.g., one or more later incremental snapshots) in the snapshot chain may depend on them. In some systems, expired snapshots may be consolidated (e.g., merged) with the next unexpired snapshot in the chain to reclaim storage space.

In some archival storage systems (e.g., cloud environments), computational operations, such as consolidation operations, may be more expensive relative to storage space, such that frequent consolidation operations may be disfavored (e.g., as the additional processing resources or time associated with such consolidation operations may be more expensive than the storage space they reclaim). However, the longer a snapshot chain becomes, the more latency may be associated with a recovery operation for the target computing system (e.g., due to traversing a longer chain of incremental snapshots to fully restore the target computing system). Further, although storage space may be relatively affordable compared to extensive computational operations (e.g., consolidation operations), additional storage space may nevertheless incur added costs and storage costs may grow undesirably large over time. Additionally or alternatively, accessing the storage space in connection with consolidation or other processing-intensive operations may incur costs (e.g., performing read or write operations may be relatively expensive for some archival storage systems).

Accordingly, in some systems, snapshot chains may be limited to a threshold chain length (e.g., 60). After hitting the threshold, a new chain may be created with a new full snapshot and additional incremental snapshots. This way, once every snapshot in a chain expires, the entire chain may be deleted and consolidation operations can be avoided. However, full snapshots use a relatively large storage space compared to incremental snapshots, and further, one or more snapshots in each chain may have a relatively long retention policy. For example, if a full snapshot is taken every two months (e.g., every 60 days), and if each full snapshot is retained for a year, the storage system may have six snapshot chains using a relatively large amount of storage space at any moment during the year. Accordingly, it may be beneficial to reduce the storage space used by retained snapshot chains without performing expensive computation operations.

Techniques described herein enable a data management system (DMS) to store snapshots at different hierarchal levels corresponding to different snapshot frequencies (e.g., dailies, weeklies, monthlies), rather than all at one level (e.g., chains of 60 dailies). For example, after obtaining six daily snapshots (“dailies”) comprising a first full snapshot and then five subsequent incremental dailies, the DMS may generate a weekly incremental snapshot (a “weekly”) that points to (e.g., depends on, includes differential data relative to) the base snapshot (e.g., the first daily, which was a full snapshot) rather than the daily incremental snapshot from the prior day. The next six dailies may be incremental snapshots that point to the weekly, and so on. Similar techniques may be used for additional levels of snapshots, such as monthly snapshots (“monthlies”) or yearly snapshots (“yearlies”). For example, at the end of each month, the DMS may generate a monthly that depends on the initial base daily snapshot, and at the end of a year, the DMS may generate a yearly that depends on the initial base daily snapshot, thereby creating multiple hierarchical levels (e.g., frequency levels) of incremental snapshots relative to a single base snapshot.

When the first set of incremental dailies expire, the DMS may garbage collect the expired incremental dailies because the weekly incremental snapshot and other subsequent snapshots do not point to the expired incremental dailies (as in current 60-length chain systems). Additionally, or alternatively, a new full incremental snapshot may periodically be generated to start a new hierarchical structure of subsequent snapshots, such that at some point, a prior base snapshot and associated hierarchical structure of corresponding incremental snapshots may be entirely deleted.

A snapshot frequency for a given level of snapshot may refer to the periodicity (e.g., cadence) with which a snapshot of that level may be generated (e.g., a set duration of time between successive snapshots of that snapshot level). The hierarchal structure of different snapshot frequency levels may expand for any quantity of snapshot frequencies (e.g., minutelies, hourlies, weeklies, monthlies, yearlies, etc.). Hierarchically storing snapshots may enable faster garbage collection operations (e.g., as snapshots with lower retention are not pinned/depended on snapshots with higher retention) and fewer full snapshots, which may significantly reduce storage costs, avoid computational costs, or both, among other potential benefits.

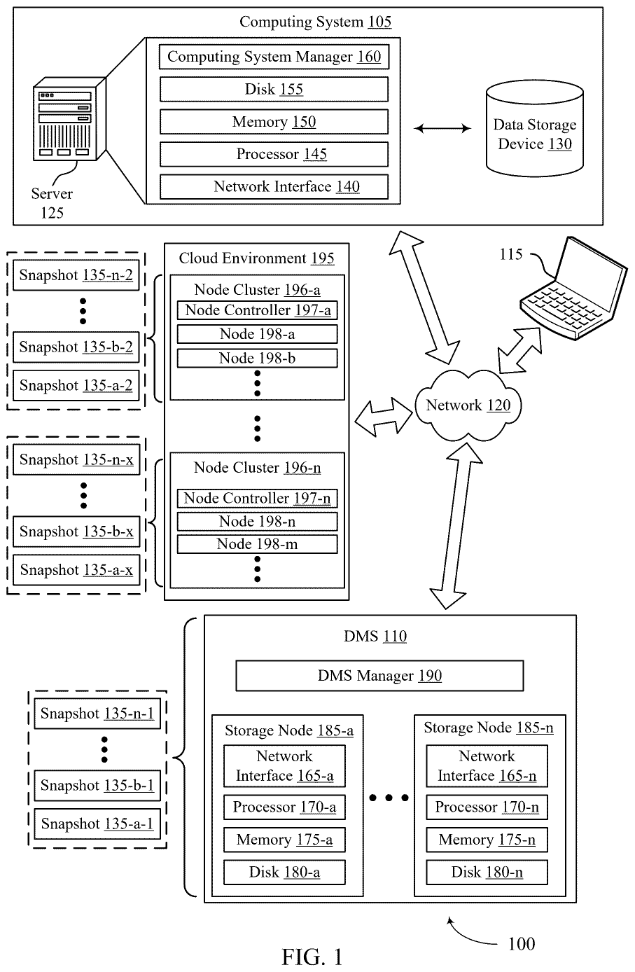

FIG. 1 illustrates an example of a computing environment 100 that supports hierarchal snapshot retention storage in accordance with aspects of the present disclosure. The computing environment 100 may include a computing system 105, a data management system (DMS) 110, and one or more computing devices 115, which may be in communication with one another via a network 120. The computing system 105 may generate, store, process, modify, or otherwise use associated data, and the DMS 110 may provide one or more data management services for the computing system 105. For example, the DMS 110 may provide a data backup service, a data recovery service, a data classification service, a data transfer or replication service, one or more other data management services, or any combination thereof for data associated with the computing system 105.

The network 120 may allow the one or more computing devices 115, the computing system 105, and the DMS 110 to communicate (e.g., exchange information) with one another. The network 120 may include aspects of one or more wired networks (e.g., the Internet), one or more wireless networks (e.g., cellular networks), or any combination thereof. The network 120 may include aspects of one or more public networks or private networks, as well as secured or unsecured networks, or any combination thereof. The network 120 also may include any quantity of communications links and any quantity of hubs, bridges, routers, switches, ports or other physical or logical network components.

A computing device 115 may be used to input information to or receive information from the computing system 105, the DMS 110, or both. For example, a user of the computing device 115 may provide user inputs via the computing device 115, which may result in commands, data, or any combination thereof being communicated via the network 120 to the computing system 105, the DMS 110, or both. Additionally, or alternatively, a computing device 115 may output (e.g., display) data or other information received from the computing system 105, the DMS 110, or both. A user of a computing device 115 may, for example, use the computing device 115 to interact with one or more user interfaces (e.g., graphical user interfaces (GUIs)) to operate or otherwise interact with the computing system 105, the DMS 110, or both. Though one computing device 115 is shown in FIG. 1, it is to be understood that the computing environment 100 may include any quantity of computing devices 115.

A computing device 115 may be a stationary device (e.g., a desktop computer or access point) or a mobile device (e.g., a laptop computer, tablet computer, or cellular phone). In some examples, a computing device 115 may be a commercial computing device, such as a server or collection of servers. And in some examples, a computing device 115 may be a virtual device (e.g., a virtual machine). Though shown as a separate device in the example computing environment of FIG. 1, it is to be understood that in some cases a computing device 115 may be included in (e.g., may be a component of) the computing system 105 or the DMS 110.

The computing system 105 may include one or more servers 125 and may provide (e.g., to the one or more computing devices 115) local or remote access to applications, databases, or files stored within the computing system 105. The computing system 105 may further include one or more data storage devices 130. Though one server 125 and one data storage device 130 are shown in FIG. 1, it is to be understood that the computing system 105 may include any quantity of servers 125 and any quantity of data storage devices 130, which may be in communication with one another and collectively perform one or more functions ascribed herein to the server 125 and data storage device 130.

A data storage device 130 may include one or more hardware storage devices operable to store data, such as one or more hard disk drives (HDDs), magnetic tape drives, solid-state drives (SSDs), storage area network (SAN) storage devices, or network-attached storage (NAS) devices. In some cases, a data storage device 130 may comprise a tiered data storage infrastructure (or a portion of a tiered data storage infrastructure). A tiered data storage infrastructure may allow for the movement of data across different tiers of the data storage infrastructure between higher-cost, higher-performance storage devices (e.g., SSDs and HDDs) and relatively lower-cost, lower-performance storage devices (e.g., magnetic tape drives). In some examples, a data storage device 130 may be a database (e.g., a relational database), and a server 125 may host (e.g., provide a database management system for) the database.

A server 125 may allow a client (e.g., a computing device 115) to download information or files (e.g., executable, text, application, audio, image, or video files) from the computing system 105, to upload such information or files to the computing system 105, or to perform a search query related to particular information stored by the computing system 105. In some examples, a server 125 may act as an application server or a file server. In general, a server 125 may refer to one or more hardware devices that act as the host in a client-server relationship or a software process that shares a resource with or performs work for one or more clients.

A server 125 may include a network interface 140, processor 145, memory 150, disk 155, and computing system manager 160. The network interface 140 may enable the server 125 to connect to and exchange information via the network 120 (e.g., using one or more network protocols). The network interface 140 may include one or more wireless network interfaces, one or more wired network interfaces, or any combination thereof. The processor 145 may execute computer-readable instructions stored in the memory 150 in order to cause the server 125 to perform functions ascribed herein to the server 125. The processor 145 may include one or more processing units, such as one or more central processing units (CPUs), one or more graphics processing units (GPUs), or any combination thereof. The memory 150 may comprise one or more types of memory (e.g., random access memory (RAM), static random access memory (SRAM), dynamic random access memory (DRAM), read-only memory (ROM), electrically erasable programmable read-only memory (EEPROM), Flash, etc.). Disk 155 may include one or more HDDs, one or more SSDs, or any combination thereof. Memory 150 and disk 155 may comprise hardware storage devices. The computing system manager 160 may manage the computing system 105 or aspects thereof (e.g., based on instructions stored in the memory 150 and executed by the processor 145) to perform functions ascribed herein to the computing system 105. In some examples, the network interface 140, processor 145, memory 150, and disk 155 may be included in a hardware layer of a server 125, and the computing system manager 160 may be included in a software layer of the server 125. In some cases, the computing system manager 160 may be distributed across (e.g., implemented by) multiple servers 125 within the computing system 105.

In some examples, the computing system 105 or aspects thereof may be implemented within one or more cloud computing environments, which may alternatively be referred to as cloud environments. Cloud computing may refer to Internet-based computing, wherein shared resources, software, and/or information may be provided to one or more computing devices on-demand via the Internet. A cloud environment may be provided by a cloud platform, where the cloud platform may include physical hardware components (e.g., servers) and software components (e.g., operating system) that implement the cloud environment. A cloud environment may implement the computing system 105 or aspects thereof through Software-as-a-Service (Saas) or Infrastructure-as-a-Service (IaaS) services provided by the cloud environment. SaaS may refer to a software distribution model in which applications are hosted by a service provider and made available to one or more client devices over a network (e.g., to one or more computing devices 115 over the network 120). IaaS may refer to a service in which physical computing resources are used to instantiate one or more virtual machines, the resources of which are made available to one or more client devices over a network (e.g., to one or more computing devices 115 over the network 120).

In some examples, the computing system 105 or aspects thereof may implement or be implemented by one or more virtual machines. The one or more virtual machines may run various applications, such as a database server, an application server, or a web server. For example, a server 125 may be used to host (e.g., create, manage) one or more virtual machines, and the computing system manager 160 may manage a virtualized infrastructure within the computing system 105 and perform management operations associated with the virtualized infrastructure. The computing system manager 160 may manage the provisioning of virtual machines running within the virtualized infrastructure and provide an interface to a computing device 115 interacting with the virtualized infrastructure. For example, the computing system manager 160 may be or include a hypervisor and may perform various virtual machine-related tasks, such as cloning virtual machines, creating new virtual machines, monitoring the state of virtual machines, moving virtual machines between physical hosts for load balancing purposes, and facilitating backups of virtual machines. In some examples, the virtual machines, the hypervisor, or both, may virtualize and make available resources of the disk 155, the memory, the processor 145, the network interface 140, the data storage device 130, or any combination thereof in support of running the various applications. Storage resources (e.g., the disk 155, the memory 150, or the data storage device 130) that are virtualized may be accessed by applications as a virtual disk.

The DMS 110 may provide one or more data management services for data associated with the computing system 105 and may include DMS manager 190 and any quantity of storage nodes 185. The DMS manager 190 may manage operation of the DMS 110, including the storage nodes 185. Though illustrated as a separate entity within the DMS 110, the DMS manager 190 may in some cases be implemented (e.g., as a software application) by one or more of the storage nodes 185. In some examples, the storage nodes 185 may be included in a hardware layer of the DMS 110, and the DMS manager 190 may be included in a software layer of the DMS 110. In the example illustrated in FIG. 1, the DMS 110 is separate from the computing system 105 but in communication with the computing system 105 via the network 120. It is to be understood, however, that in some examples at least some aspects of the DMS 110 may be located within computing system 105. For example, one or more servers 125, one or more data storage devices 130, and at least some aspects of the DMS 110 may be implemented within the same cloud environment or within the same data center.

Storage nodes 185 of the DMS 110 may include respective network interfaces 165, processors 170, memories 175, and disks 180. The network interfaces 165 may enable the storage nodes 185 to connect to one another, to the network 120, or both. A network interface 165 may include one or more wireless network interfaces, one or more wired network interfaces, or any combination thereof. The processor 170 of a storage node 185 may execute computer-readable instructions stored in the memory 175 of the storage node 185 in order to cause the storage node 185 to perform processes described herein as performed by the storage node 185. A processor 170 may include one or more processing units, such as one or more CPUs, one or more GPUs, or any combination thereof. The memory 150 may comprise one or more types of memory (e.g., RAM, SRAM, DRAM, ROM, EEPROM, Flash, etc.). A disk 180 may include one or more HDDs, one or more SDDs, or any combination thereof. Memories 175 and disks 180 may comprise hardware storage devices. Collectively, the storage nodes 185 may in some cases be referred to as a storage cluster or as a cluster of storage nodes 185.

The DMS 110 may provide a backup and recovery service for the computing system 105. For example, the DMS 110 may manage the extraction and storage of snapshots 135 associated with different point-in-time versions of one or more target computing objects within the computing system 105. A snapshot 135 of a computing object (e.g., a virtual machine, a database, a filesystem, a virtual disk, a virtual desktop, or other type of computing system or storage system) may be a file (or set of files) that represents a state of the computing object (e.g., the data thereof) as of a particular point in time. A snapshot 135 may also be used to restore (e.g., recover) the corresponding computing object as of the particular point in time corresponding to the snapshot 135. In some cases, a computing object that is the subject of a snapshot 135 may be or include a collection of multiple objects (e.g., computing objects may have hierarchical relationships, with lower-level computing objects included within one or more higher-level computing objects). For example, a filesystem may include multiple files, and along with the filesystem being a computing object, the files therein may also be computing objects. Or, as another example, a database may include multiple tables, and along with the database being a computing object, the tables therein may also be computing objects. Thus, a snapshot may be of one or more computing objects, and a snapshot of a first computing object (e.g., a higher-level computing object) may also be a snapshot of each computing object (e.g., each lower-level computing object) that is included in (e.g., is a member or component of) the first computing object. Additionally, a snapshot may be of one or more lower-level computing objects individually (e.g., a snapshot of a lower-level computing object may be separate from another snapshot of another lower-level computing object, separate from another snapshot of a higher-level computing object that contains the lower-level computing object, or both).

A computing object of which a snapshot 135 may be generated may be referred to as snappable. Snapshots 135 may be generated at different times (e.g., periodically or on some other scheduled or configured basis) in order to represent the state of the computing system 105 or aspects thereof as of those different times. In some examples, a snapshot 135 may include metadata that defines a state of the computing object as of a particular point in time. For example, a snapshot 135 may include metadata associated with (e.g., that defines a state of) some or all data blocks included in (e.g., stored by or otherwise included in) the computing object. Snapshots 135 (e.g., collectively) may capture changes in the data blocks over time. Snapshots 135 generated for the target computing objects within the computing system 105 may be stored in one or more storage locations (e.g., the disk 155, memory 150, the data storage device 130) of the computing system 105, in the alternative or in addition to being stored within the DMS 110, as described below.

To obtain a snapshot 135 of a target computing object associated with the computing system 105 (e.g., of the entirety of the computing system 105 or some portion thereof, such as one or more databases, virtual machines, or filesystems within the computing system 105), the DMS manager 190 may transmit a snapshot request to the computing system manager 160. In response to the snapshot request, the computing system manager 160 may set the target computing object into a frozen state (e.g., a read-only state). Setting the target computing object into a frozen state may allow a point-in-time snapshot 135 of the target computing object to be stored or transferred.

In some examples, the computing system 105 may generate the snapshot 135 based on the frozen state of the computing object. For example, the computing system 105 may execute an agent of the DMS 110 (e.g., the agent may be software installed at and executed by one or more servers 125), and the agent may cause the computing system 105 to generate the snapshot 135 and transfer the snapshot 135 to the DMS 110 in response to the request from the DMS 110. In some examples, the computing system manager 160 may cause the computing system 105 to transfer, to the DMS 110, data that represents the frozen state of the target computing object, and the DMS 110 may generate a snapshot 135 of the target computing object based on the corresponding data received from the computing system 105.

Once the DMS 110 receives, generates, or otherwise obtains a snapshot 135, the DMS 110 may store the snapshot 135 at one or more of the storage nodes 185. The DMS 110 may store a snapshot 135 at multiple storage nodes 185, for example, for improved reliability. Additionally, or alternatively, snapshots 135 may be stored in some other location connected with the network 120. For example, the DMS 110 may store more recent snapshots 135 at the storage nodes 185, and the DMS 110 may transfer less recent snapshots 135 via the network 120 to a cloud environment (which may include or be separate from the computing system 105) for storage at the cloud environment, a magnetic tape storage device, or another storage system separate from the DMS 110.

Updates made to a target computing object that has been set into a frozen state may be written by the computing system 105 to a separate file (e.g., an update file) or other entity within the computing system 105 while the target computing object is in the frozen state. After the snapshot 135 (or associated data) of the target computing object has been transferred to the DMS 110, the computing system manager 160 may release the target computing object from the frozen state, and any corresponding updates written to the separate file or other entity may be merged into the target computing object.

In response to a restore command (e.g., from a computing device 115 or the computing system 105), the DMS 110 may restore a target version (e.g., corresponding to a particular point in time) of a computing object based on a corresponding snapshot 135 of the computing object. In some examples, the corresponding snapshot 135 may be used to restore the target version based on data of the computing object as stored at the computing system 105 (e.g., based on information included in the corresponding snapshot 135 and other information stored at the computing system 105, the computing object may be restored to its state as of the particular point in time). Additionally, or alternatively, the corresponding snapshot 135 may be used to restore the data of the target version based on data of the computing object as included in one or more backup copies of the computing object (e.g., file-level backup copies or image-level backup copies). Such backup copies of the computing object may be generated in conjunction with or according to a separate schedule than the snapshots 135. For example, the target version of the computing object may be restored based on the information in a snapshot 135 and based on information included in a backup copy of the target object generated prior to the time corresponding to the target version. Backup copies of the computing object may be stored at the DMS 110 (e.g., in the storage nodes 185) or in some other location connected with the network 120 (e.g., in a cloud environment, which in some cases may be separate from the computing system 105).

In some examples, the DMS 110 may restore the target version of the computing object and transfer the data of the restored computing object to the computing system 105. And in some examples, the DMS 110 may transfer one or more snapshots 135 to the computing system 105, and restoration of the target version of the computing object may occur at the computing system 105 (e.g., as managed by an agent of the DMS 110, where the agent may be installed and operate at the computing system 105).

In response to a mount command (e.g., from a computing device 115 or the computing system 105), the DMS 110 may instantiate data associated with a point-in-time version of a computing object based on a snapshot 135 corresponding to the computing object (e.g., along with data included in a backup copy of the computing object) and the point-in-time. The DMS 110 may then allow the computing system 105 to read or modify the instantiated data (e.g., without transferring the instantiated data to the computing system). In some examples, the DMS 110 may instantiate (e.g., virtually mount) some or all of the data associated with the point-in-time version of the computing object for access by the computing system 105, the DMS 110, or the computing device 115.

In some examples, the DMS 110 may store different types of snapshots 135, including for the same computing object. For example, the DMS 110 may store both base snapshots 135 and incremental snapshots 135. A base snapshot 135 may represent the entirety of the state of the corresponding computing object as of a point in time corresponding to the base snapshot 135. A base snapshot 135 may alternatively be referred to as a full snapshot 135. An incremental snapshot 135 may represent the changes to the state-which may be referred to as the delta-of the corresponding computing object that have occurred between an earlier or later point in time corresponding to another snapshot 135 (e.g., another base snapshot 135 or incremental snapshot 135) of the computing object and the incremental snapshot 135. In some cases, some incremental snapshots 135 may be forward-incremental snapshots 135 and other incremental snapshots 135 may be reverse-incremental snapshots 135. To generate a base snapshot 135 of a computing object using a forward-incremental snapshot 135, the information of the forward-incremental snapshot 135 may be combined with (e.g., applied to) the information of an earlier base snapshot 135 of the computing object along with the information of any intervening forward-incremental snapshots 135, where the earlier base snapshot 135 may include a base snapshot 135 and one or more reverse-incremental or forward-incremental snapshots 135. To generate a base snapshot 135 of a computing object using a reverse-incremental snapshot 135, the information of the reverse-incremental snapshot 135 may be combined with (e.g., applied to) the information of a later base snapshot 135 of the computing object along with the information of any intervening reverse-incremental snapshots 135.

In some examples, the DMS 110 may provide a data classification service, a malware detection service, a data transfer or replication service, backup verification service, or any combination thereof, among other possible data management services for data associated with the computing system 105. For example, the DMS 110 may analyze data included in one or more computing objects of the computing system 105, metadata for one or more computing objects of the computing system 105, or any combination thereof, and based on such analysis, the DMS 110 may identify locations within the computing system 105 that include data of one or more target data types (e.g., sensitive data, such as data subject to privacy regulations or otherwise of particular interest) and output related information (e.g., for display to a user via a computing device 115). Additionally, or alternatively, the DMS 110 may detect whether aspects of the computing system 105 have been impacted by malware (e.g., ransomware). Additionally, or alternatively, the DMS 110 may relocate data or create copies of data based on using one or more snapshots 135 to restore the associated computing object within its original location or at a new location (e.g., a new location within a different computing system 105). Additionally, or alternatively, the DMS 110 may analyze backup data to ensure that the underlying data (e.g., user data or metadata) has not been corrupted. The DMS 110 may perform such data classification, malware detection, data transfer or replication, or backup verification, for example, based on data included in snapshots 135 or backup copies of the computing system 105, rather than live contents of the computing system 105, which may beneficially avoid adversely affecting (e.g., infecting, loading, etc.) the computing system 105.

In some examples, the DMS 110, and in particular the DMS manager 190, may be referred to as a control plane. The control plane may manage tasks, such as storing data management data or performing restorations, among other possible examples. The control plane may be common to multiple customers or tenants of the DMS 110. For example, the computing system 105 may be associated with a first customer or tenant of the DMS 110, and the DMS 110 may similarly provide data management services for one or more other computing systems associated with one or more additional customers or tenants. In some examples, the control plane may be configured to manage the transfer of data management data (e.g., snapshots 135 associated with the computing system 105) to a cloud environment 195 (e.g., Microsoft Azure or Amazon Web Services). In addition, or as an alternative, to being configured to manage the transfer of data management data to the cloud environment 195, the control plane may be configured to transfer metadata for the data management data to the cloud environment 195. The metadata may be configured to facilitate storage of the stored data management data, the management of the stored management data, the processing of the stored management data, the restoration of the stored data management data, and the like.

Each customer or tenant of the DMS 110 may have a private data plane, where a data plane may include a location at which customer or tenant data is stored. For example, each private data plane for each customer or tenant may include a node cluster 196 across which data (e.g., data management data, metadata for data management data, etc.) for a customer or tenant is stored. Each node cluster 196 may include a node controller 197 which manages the nodes 198 of the node cluster 196. As an example, a node cluster 196 for one tenant or customer may be hosted on Microsoft Azure, and another node cluster 196 may be hosted on Amazon Web Services. In another example, multiple separate node clusters 196 for multiple different customers or tenants may be hosted on Microsoft Azure. Separating each customer or tenant's data into separate node clusters 196 provides fault isolation for the different customers or tenants and provides security by limiting access to data for each customer or tenant.

The control plane (e.g., the DMS 110, and specifically the DMS manager 190) manages tasks, such as storing backups or snapshots 135 or performing restorations, across the multiple node clusters 196. For example, as described herein, a node cluster 196-a may be associated with the first customer or tenant associated with the computing system 105. The DMS 110 may obtain (e.g., generate or receive) and transfer the snapshots 135 associated with the computing system 105 to the node cluster 196-a in accordance with a service level agreement for the first customer or tenant associated with the computing system 105. For example, a service level agreement may define backup and recovery parameters for a customer or tenant such as snapshot generation frequency, which computing objects to backup, where to store the snapshots 135 (e.g., which private data plane), and how long to retain snapshots 135. As described herein, the control plane may provide data management services for another computing system associated with another customer or tenant. For example, the control plane may generate and transfer snapshots 135 for another computing system associated with another customer or tenant to the node cluster 196-n in accordance with the service level agreement for the other customer or tenant.

To manage tasks, such as storing backups or snapshots 135 or performing restorations, across the multiple node clusters 196, the control plane (e.g., the DMS manager 190) may communicate with the node controllers 197 for the various node clusters via the network 120. For example, the control plane may exchange communications for backup and recovery tasks with the node controllers 197 in the form of transmission control protocol (TCP) packets via the network 120.

Some backup and recovery systems may use snapshot chains, where snapshots 135 of a target computing system are stored as chains that include a base snapshot 135 along with one or more incremental snapshots 135, with each incremental snapshot 135 reflecting the changes to the target computing system since a time corresponding to a prior snapshot 135 in the chain. Snapshots 135 may expire (e.g., no longer be required to be retained) over time in accordance with a retention policy. As snapshots 135 expire, they may not immediately be garbage collected because other snapshots 135 (e.g., one or more later incremental snapshots) in the snapshot chain may depend on them. In some systems, the DMS 110 may consolidate expired snapshots with the next unexpired snapshot 135 in the chain to reclaim storage space.

In some archival storage systems (e.g., cloud environments), computational operations, such as consolidation operations, may be more expensive relative to storage space, such that frequent consolidation operations may be disfavored (e.g., as the additional processing resources or time associated with such consolidation operations may be more expensive than the storage space they reclaim). However, the longer a snapshot chain becomes, the more latency may be associated with a recovery operation for the target computing system (e.g., due to the DMS 110 traversing a longer chain of incremental snapshots 135 to fully restore the target computing system). Further, although storage space may be relatively affordable compared to extensive computational operations (e.g., consolidation operations), additional storage space may nevertheless incur added costs and storage costs may grow undesirably large over time. Accordingly, in some systems, snapshot chains may be limited to a threshold chain length (e.g., 60). After hitting the threshold, a new chain may be created with a new full snapshot 135 and additional incremental snapshots 135. This way, once every snapshot 135 in a chain expires, the entire chain may be deleted and consolidation operations can be avoided. However, full snapshots 135 use a relatively large storage space compared to incremental snapshots 135, and further, the full snapshots 135 in each chain may have a relatively long retention policy. For example, if a full snapshot 135 is taken every two months (e.g., every 60 days), and if each full snapshot is retained for a year, the storage system may have six snapshot chains using a relatively large amount of storage space at any moment during the year. Accordingly, it may be beneficial to reduce the storage space used by retained snapshot chains without performing expensive computation operations.

Techniques described herein enable the DMS 110 to store snapshots 135 at different hierarchal levels corresponding to different snapshot frequencies (e.g., dailies, weeklies, monthlies), rather than all at one level (e.g., chains of 60 dailies). For example, after obtaining six daily snapshots 135 (“dailies”) comprising a first full snapshot 135 and then five subsequent incremental dailies, the DMS 110 may generate a weekly incremental snapshot 135 (a “weekly”) that points to (e.g., depends on, includes differential data relative to) the base snapshot 135 (e.g., the first daily, which was a full snapshot) rather than the daily incremental snapshot 135 from the prior day. The next six dailies may be incremental snapshots 135 that point to the weekly, and so on. Similar techniques may be used for additional levels of snapshots 135, such as monthly snapshots 135 (“monthlies”) or yearly snapshots 135 (“yearlies”)—e.g., at the end of each month, the DMS 110 may generate a monthly that depends on the initial base daily snapshot 135, and at the end of a year, the DMS 110 may generate a yearly that depends on the initial base daily snapshot 135, thereby creating multiple hierarchical levels (e.g., frequency levels) of incremental snapshots 135 relative to a single base snapshot 135.

When the first set of incremental dailies expire, the DMS 110 may garbage collect the expired incremental dailies because the weekly incremental snapshot 135 and other subsequent snapshots 135 do not point to the expired incremental dailies (as in current 60-length chain systems). Additionally, or alternatively, a new full incremental snapshot 135 may periodically be generated to start a new hierarchical structure of subsequent snapshots 135, such that at some point, a prior base snapshot 135 and associated hierarchical structure of corresponding incremental snapshots 135 may be entirely deleted.

The hierarchal structure of different snapshot frequency levels may expand for any quantity of snapshot frequencies (e.g., minutelies, hourlies, weeklies, monthlies, yearlies, etc.). Hierarchically storing snapshots 135 may enable faster garbage collection operations (e.g., as snapshots with lower retention are not pinned/depended on snapshots 135 with higher retention) and fewer full snapshots, which may significantly reduce storage costs, avoid computational costs, or both, among other potential benefits.

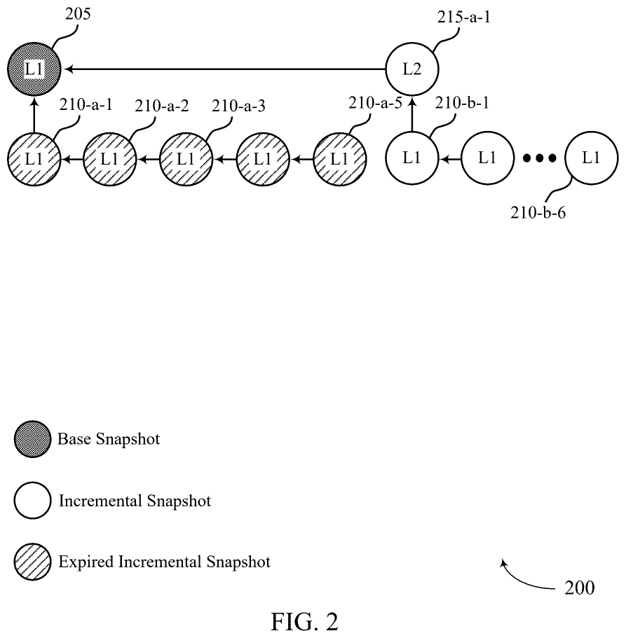

FIG. 2 shows an example of a hierarchal snapshot diagram 200 that supports hierarchal snapshot retention storage in accordance with aspects of the present disclosure. The hierarchal snapshot diagram 200 may implement or be implemented by aspects of the computing environment 100 described with reference to FIG. 1. For example, a DMS (e.g., a DMS 110 as described with reference to FIG. 1) may generate the hierarchal snapshot diagram 200. The hierarchal snapshot diagram 200 may include a base snapshot 205 (also referred to as a full snapshot) and one or more incremental snapshots. The base snapshot 205 and the incremental snapshots may be examples of the snapshots 135 as described with reference to FIG. 1.

Incremental snapshots may depend on a respective previous snapshot. For example, snapshot 210-a-2 may depend on (e.g., include data that references) snapshot 210-a-1 (e.g., that in turn depends on base snapshot 205). In some backup and recovery systems, the snapshots may expire (e.g., may no longer be retained by the DMS) over time in accordance with a retention policy. For example, each snapshot may be stored for a threshold duration (e.g., days, weeks, months) before expiring. In such systems, the DMS may perform a data consolidation operation on the expired snapshots and may reclaim storage space corresponding to the expired snapshots based on performing the data consolidation operation.

The data consolidation operation may consolidate (e.g., merge) data in expired snapshots with a next unexpired snapshot to reclaim storage space in a storage environment for the snapshots. In some examples, expired snapshots may not be immediately deleted (e.g., garbage collected) because other incremental snapshots may depend on the expired snapshots (e.g., snapshot 210-a-3 may depend on snapshot 210-a-2 after snapshot 210-a-2 expires). The consolidation operation may enable the DMS to delete the expired snapshots, such as snapshot 210-a-2, by merging relevant data (e.g., the data referenced by the next unexpired snapshot) in the expired snapshot with the next unexpired snapshot, such as snapshot 210-a-3.

However, in some storage systems, consolidation operations may be associated with computational costs, data access costs, data ingress or egress costs, or any combination thereof. For example, in some archival storage systems or cloud environments, performing computational operations may be more expensive relative to storage space, and frequent consolidation operations may be disfavored. For example, in a cloud environment, the DMS may launch a computation node to perform the computational operations whereas in a non-cloud environment, computation nodes may be continuously (or substantially continuously) deployed. In such storage systems, the DMS may implement a threshold snapshot chain length (e.g., 60 snapshots) for the snapshots. That is, the DMS may store a base snapshot and at most 60 incremental snapshots in a snapshot chain. The longer a respective snapshot chain becomes (e.g., as more incremental snapshots are added), the more latency may be associated with a recovery operation for the target computing object (e.g., due to the DMS traversing a longer chain of incremental snapshots to restore a target computing object).

After hitting the threshold chain length for a respective snapshot chain, the DMS may generate a new snapshot chain with a new base snapshot and a quantity of incremental snapshots. The DMS may delete a snapshot chain once all snapshots in the snapshot chain expire. Deleting, or garbage collecting, the expired snapshot chains may enable the DMS to reclaim space from the expired snapshots without performing a consolidation operation (e.g., garbage collection may have a reduced computational cost compared to the consolidation operation which reads and writes data included in the snapshots). However, base snapshots may use a relatively large storage space compared to incremental snapshots (e.g., an incremental snapshot may be on the order of 1% the size of a base snapshot), and further, the base snapshots in each snapshot chain may have a relatively long retention policy. For example, if a base snapshot is taken every two months (e.g., every 60 days), and if the DMS retains each base snapshot for a year, the storage system may store up to six snapshot chains using a relatively large amount of storage space (e.g., and increasing cost to store the six snapshot chains) at any moment during a year. Accordingly, it may be beneficial to reduce the storage space used by retained base snapshots without performing expensive computation operations.

In accordance with the techniques described herein, the DMS may store snapshots at different hierarchal levels in accordance with different snapshot frequencies (e.g., how often a snapshot is taken). For example, the DMS may generate and store one or more first-level snapshots 210 in accordance with a first snapshot frequency, L1, and generate and store one or more second-level snapshot 215 in accordance with a second snapshot frequency, L2. The DMS may store a first second-level snapshot 215-a-1 as an incremental snapshot relative to the base snapshot 205 (e.g., thus starting a new hierarchal level) rather than storing the snapshot 215-a-1 as an incremental to a previous first-level snapshot 210 (e.g., snapshot 210-a-5). Subsequent second-level snapshots 215-a may depend on the snapshot 215-a-1 until a snapshot is generated in accordance with a third snapshot frequency and a third level is started.

In some cases, the first snapshot frequency may correspond to a daily snapshot frequency and the second snapshot frequency may correspond to a weekly snapshot frequency, although it is to be understood that L1 and L2 may be any two different snapshot frequencies (e.g., L1 may be monthly and L2 may be yearly, or L1 may be minutely and L2 may be hourly). Moreover, it is to be understood that the techniques described herein may apply to any quantity of snapshot frequencies and levels (e.g., the DMS may generate any quantity of levels of snapshots corresponding to any quantity of different snapshot frequencies).

In the hierarchal snapshot diagram 200, a first set of the first-level snapshots 210-a (e.g., the snapshots 210-a-1 through 210-a-5) may depend on the base snapshot 205 (e.g., a full snapshot) of a target computing object. That is, incremental snapshot 210-a-1 may include differential data relative to the base snapshot 205, and each other first-level snapshot 210-a in the first set (e.g., snapshots 210-a-2 through 210-a-5) may include differential data relative to a respective previous first-level snapshot 210-a in the first set of first-level snapshots 210-a. In an example, the base snapshot 205 may be a snapshot for January 1, and the first set of first-level snapshots 210-a may be daily snapshots for January 2 through January 6.

The DMS may generate the second-level snapshot 215-a-1 in accordance with the second snapshot frequency L2. The second snapshot frequency may be lower than the first snapshot frequency. In some examples, if a higher-level snapshot is generated, there may be no need for the DMS to also generate one or more lower-level snapshots that would be duplicative in content of the higher-level snapshot. For example, if the second-level snapshot 215-a-1 is generated on January 7 as a weekly snapshot, the DMS may refrain from also generating a separate, additional first-level snapshot 210-a (e.g., daily snapshot) for January 7. The second-level snapshot 215-a-1 may include differential data relative to the base snapshot 205 (e.g., thus creating a new hierarchal level).

After generating the second-level snapshot 215-a-1, the DMS may generate a second set of first-level snapshots 210-b in accordance with the first snapshot frequency. A first snapshot 210-b-1 of the first-level snapshots 210-b may include differential data relative to the second-level snapshot 215-a-1 (e.g., snapshot 210-b-1 may be a daily snapshot for January 8), and each other first-level snapshot 210-b in the second set of first-level snapshots may include differential data relative to a respective previous first-level snapshot 210-b in the second set of first-level snapshots 210-b.

By storing snapshots based on their snapshot frequency, the DMS may garbage collect (e.g., delete) individual levels after all the snapshots in a respective level expire. For example, because the second set of first-level snapshots 210-b depend on the second-level snapshot 215-a-1 (and the snapshot 215-a-1 depends on the base snapshot 205) and not on any of the first-level snapshots 210-a, the DMS may perform a garbage collection operation on the first set of first-level snapshots 210-a after the first-level snapshots 210-a expire (e.g., after the last first-level snapshot 210-a-5 expires). In other words, the first set of first-level snapshots 210-a may be deleted because no unexpired snapshot pins the sub-chain of snapshots 210-a-1 through 210-a-5, which may result in faster garbage collection operations relative to snapshot chains of other systems (e.g., that may wait until each snapshot in a relatively long chain of snapshots are expired).

Snapshots of different levels may expire in accordance with respective retention policies associated with respective snapshot frequencies. For example, first-level snapshots generated in accordance with the first snapshot frequency may expire after a first duration defined by a first snapshot retention policy (e.g., daily snapshots may expire after one week), second-level snapshots generated in accordance with the second snapshot frequency may expire after a second duration defined by a second snapshot retention policy (e.g., weekly snapshots may expire after three weeks), and so on. In some examples, the respective retention policies for each snapshot frequency may be determined based on a service-level agreement (SLA) between the DMS and one or more users of the storage environment. In an example, the DMS may garbage collect the first-level snapshots 210-a-1 through 210-a-5 after generating first-level snapshot 210-b-6 (e.g., a daily snapshot for January 13) because the snapshot 210-b-6 may be generated the first duration after the snapshot 210-a-5 was generated (e.g., snapshot 210-b-6 may occur one week after the snapshot 210-a-5).

In some examples, the DMS may generate and store snapshots at the different hierarchal levels based on respective frequency tags of the snapshots. For example, the DMS may store a snapshot in a level corresponding to its frequency tag (e.g., the DMS may store a first-level snapshot 210 as an incremental snapshot relative to a previous first-level snapshot 210 if its frequency tag indicates the first snapshot frequency). Additionally, or alternatively, the DMS may store a snapshot based on the current snapshots stored in the storage environment. For example, the DMS may determine a suitable base snapshot (e.g., determine which snapshot to be incremental to). In some examples, the DMS may determine which snapshot to be incremental to in response to computing a quantity of differential data between the snapshot and one or more other snapshots. For example, if the snapshot is a second second-level snapshot 215-a, the DMS may store the snapshot as incremental to the snapshot 215-a-1 because the quantity of differential data between the snapshot 215-a-1 and 215-a-2 may be less than a quantity of differential data between the snapshot 215-a-2 and the base snapshot 205.

By hierarchically storing snapshots in accordance with their respective snapshot frequencies, the techniques described herein may enable the DMS to perform faster garbage collection operations relative to other chain-based storage systems (e.g., as expired snapshots may not be pinned by unexpired snapshots as long as other systems), and may reduce a quantity of storage space used to store the snapshots (e.g., as the hierarchal snapshot storage may include a single full snapshot compared to other chain-based systems that may have as many as six full snapshots).

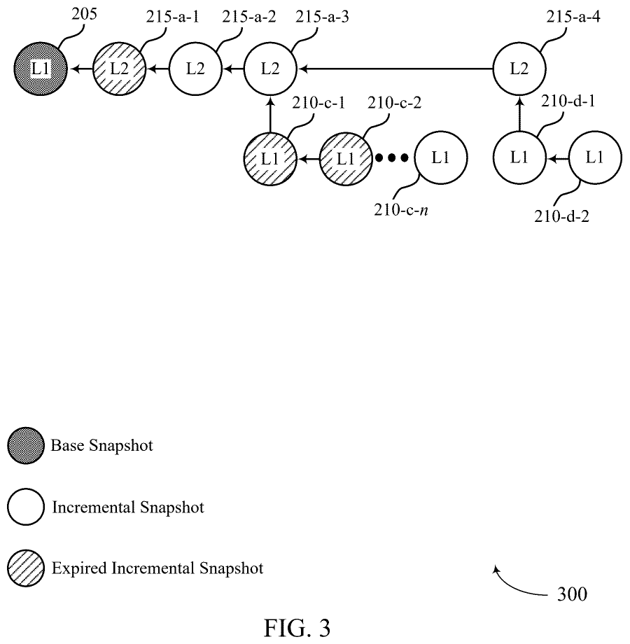

FIG. 3 shows an example of a hierarchal snapshot operation 300 that supports hierarchal snapshot retention storage in accordance with aspects of the present disclosure. In the hierarchal snapshot operation 300, the DMS may generate one or more second-level snapshots 215-a (e.g., snapshots 215-a-2 through 215-a-4). For example, the DMS may generate snapshot 215-a-2 (e.g., a second weekly snapshot, a snapshot for January 14) that includes differential data relative to the snapshot 215-a-1 (e.g., a first weekly snapshot, a snapshot for January 7). Each second-level snapshot 215-a may include a respective set of first-level snapshots 210. For example, the second-level snapshot 215-a-3 may include a set of first-level snapshots 210-c (e.g., snapshots 210-c-1 up to snapshot 210-c-n, daily snapshots of January 22 through January 27).

In some examples, the DMS may generate the second-level snapshot 215-a-4 that includes differential data relative to the second-level snapshot 215-a-3 (e.g., a fourth weekly snapshot, a weekly snapshot of January 28). First-level snapshot 210-d-1 (e.g., January 29) may include differential data relative to the second-level snapshot 215-a-4, and the first-level snapshot 210-d-2 (e.g., January 30) may include differential data relative to the first-level snapshot 210-d-1. In some cases, the second-level snapshot 215-a-1 may expire based on a second retention policy associated with the second snapshot frequency. For example, the second-level snapshot 215-a-1 may expire after the second duration (e.g., after 3 weeks, when the snapshot 215-a-4 is generated). First-level snapshots 210-c-1 and 210-c-2 may also expire based on the first retention policy associated with the first snapshot frequency. That is, the snapshots 210-c-1 and 210-c-2 may expire based on being generated a duration greater than or equal to the first duration of the first retention policy (e.g., snapshot 210-d-1 may be generated one week after snapshot 210-c-1 and snapshot 210-d-2 may be generated one week after snapshot 210-c-2).

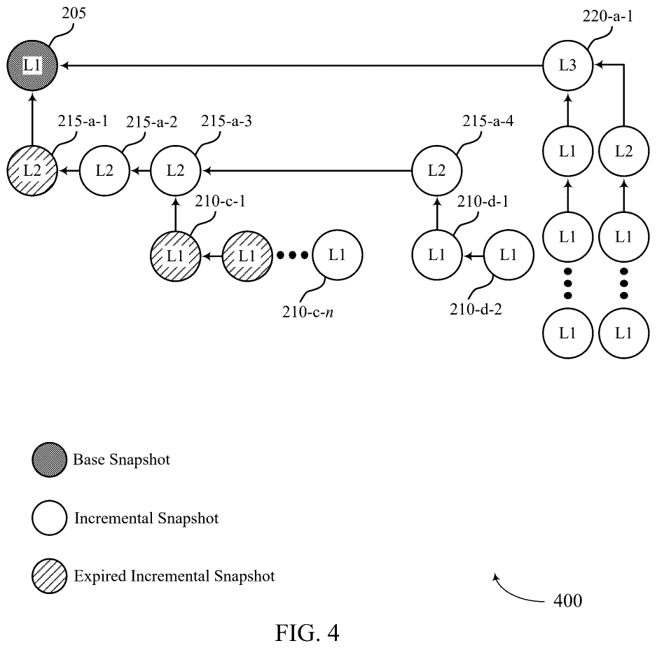

FIG. 4 shows an example of a hierarchal snapshot operation 400 that supports hierarchal snapshot retention storage in accordance with aspects of the present disclosure. In the hierarchal snapshot operation 400, the DMS may generate a first third-level snapshot 220-a-1 in accordance with a third snapshot frequency lower than the second snapshot frequency (e.g., the snapshot 220-a-1 may be a first monthly snapshot, a snapshot of January 31). The third-level snapshot 220-a-1 may include differential data relative to the base snapshot 205 (e.g., thus creating a new level of the hierarchal snapshot diagram 200).

In some examples, the DMS may generate a set of first-level incremental snapshots 210 in accordance with the first snapshot frequency, where one first-level incremental snapshot 210 in the set includes differential data relative to the third-level snapshot 220-a-1. For example, a first-level snapshot 210 may be a snapshot of February 1, and the set may include daily snapshots for February 2 through February 6 that each include differential data relative to a respective previous first-level snapshot 210 of the set of first-level snapshots 210. The DMS may generate a second-level snapshot 215 (e.g., a first weekly snapshot of February, a snapshot of February 7) that includes differential data relative to the snapshot 220-a-1.

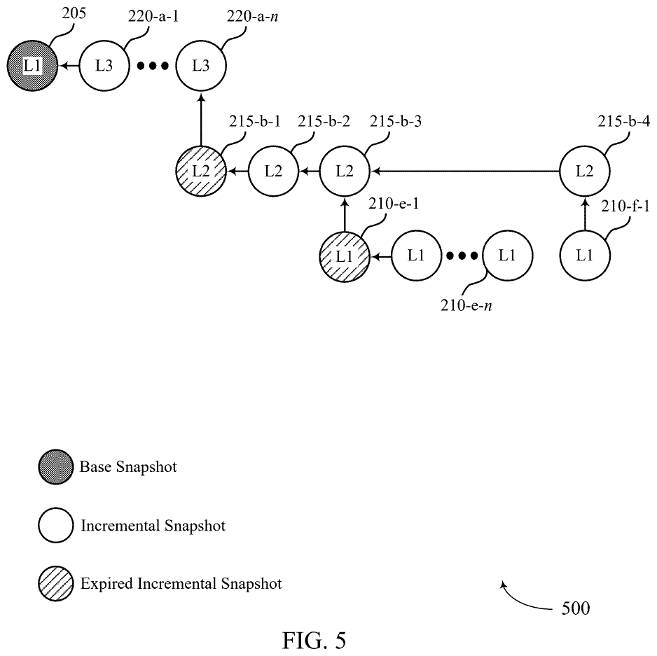

FIG. 5 shows an example of a hierarchal snapshot operation 500 that supports hierarchal snapshot retention storage in accordance with aspects of the present disclosure. In the hierarchal snapshot operation 500, the DMS may generate multiple third-level snapshots 220-a (e.g., up to a snapshot 220-a-n) in accordance with the third snapshot frequency. Each of the other third-level snapshots 220-a (e.g., excluding third-level snapshot 220-a-1) may include differential data relative to a previous third-level snapshot 220-a. For example, a second third-level snapshot 220-a-2 may include differential data relative to the third-level snapshot 220-a-1. In an example, the third-level snapshots 220-a may be monthly snapshots, and the snapshot 220-a-n may be a monthly snapshot for November 30.

Each third-level snapshot 220-a may include respective sets of second-level snapshots 215, and each second-level snapshot 215 may include a respective set of first-level snapshots 210. For example, the snapshot 220-a-n may include second-level snapshots 215-b-1 through 215-b-4 generated in accordance with the second snapshot frequency. The second-level snapshot 215-b-3 may include a set of first-level snapshots 210-e-1 through 210-e-n generated in accordance with the first snapshot frequency. For example, the second-level snapshot 215-b-3 may be a snapshot of December 22, and the first-level snapshots 210-e-1 through 210-e-n may be snapshots of December 23 through December 28.

In some examples, the DMS may delete (e.g., garbage collect) the second-level snapshots 215-a after generating the third-level snapshot 220-a-1 in accordance with the second retention policy associated with the second snapshot frequency (e.g., weeklies may be retained for 3 weeks). For example, the DMS may delete the second-level snapshots 215-a after all of the second-level snapshots 215-a are expired (e.g., after the second duration from the snapshot 215-a-4, three weeks after generating snapshot 215-a-4).

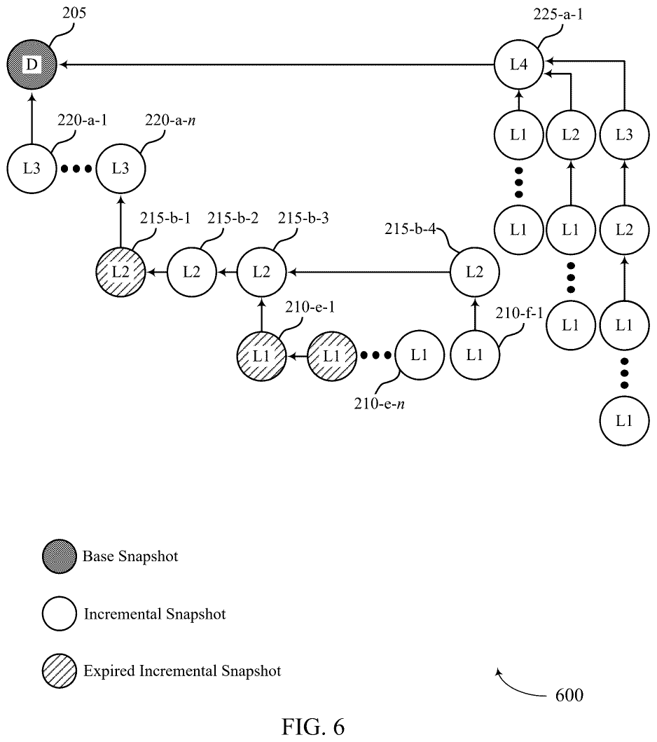

FIG. 6 shows an example of a hierarchal snapshot operation 600 that supports hierarchal snapshot retention storage in accordance with aspects of the present disclosure. In the hierarchal snapshot operation 600, the DMS may generate a fourth-level snapshot 225-a-1 (e.g., a yearly snapshot, a snapshot of December 31) in accordance with a fourth snapshot frequency. The fourth snapshot frequency may be lower than the third snapshot frequency and may be associated with a respective fourth snapshot retention policy. The fourth-level snapshot 225-a-1 may include differential data relative to the base snapshot 205 (e.g., thereby creating a fourth level of the hierarchal snapshot diagram 200).

In some examples, the DMS may generate a set of first-level snapshots 210, where a first first-level snapshot 210 may include differential data relative to the fourth-level snapshot 225-a-1 (e.g., a snapshot of January 1 of a second year) and each other first-level snapshot 210 in the set may include differential data relative to a respective previous first-level snapshot 210 (e.g., snapshots of January 2 through January 6 of the second year). The DMS may generate a second-level snapshot 215 that includes differential data relative to the fourth-level snapshot 225-a-1 (e.g., a first weekly snapshot of the second year, a snapshot of January 7). The second-level snapshot 215 may include a respective set of first-level snapshots generated in accordance with the first snapshot frequency that depend on the second-level snapshot 215. Additionally, or alternatively, the DMS may generate a third-level snapshot 220 that includes differential data relative to the fourth-level snapshot 225-a-1 (e.g., a first monthly snapshot of the second year, a snapshot of January 31).

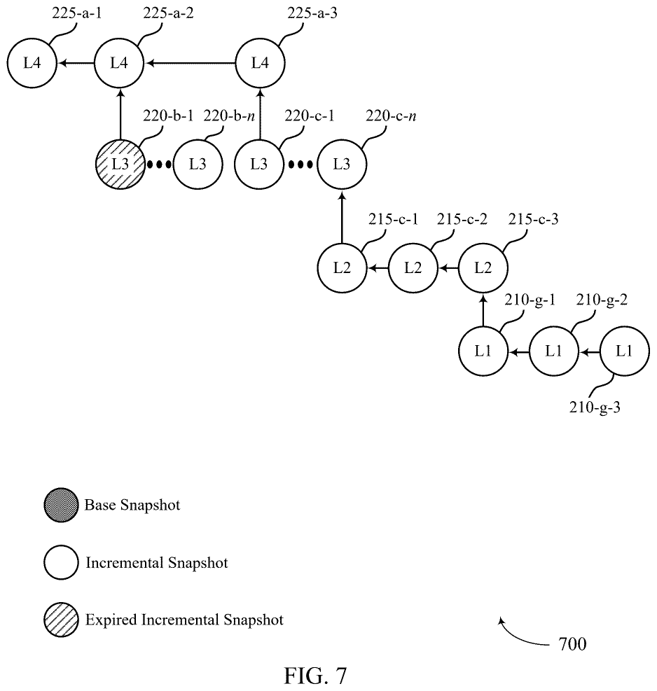

FIG. 7 shows an example of a hierarchal snapshot operation 700 that supports hierarchal snapshot retention storage in accordance with aspects of the present disclosure. In the hierarchal snapshot operation 700, the DMS may generate multiple fourth-level snapshots 225-a in accordance with the fourth snapshot frequency. Each of the other fourth-level snapshots 225-a (e.g., excluding fourth-level snapshot 225-a-1) may include differential data relative to a previous fourth-level snapshot 225-a. For example, fourth-level snapshot 225-a-2 may include differential data relative to the fourth-level snapshot 225-a-1 (which may include differential data relative to the base snapshot 205). In an example, the fourth-level snapshots 225-a may be yearly snapshots (e.g., the snapshot 225-a-2 may be a snapshot of a second year, snapshot 225-a-3 may be a snapshot of a third year).

Each fourth-level snapshot 225-a may include respective sets of third-level snapshots 220, each third-level snapshot 220 may include respective sets of second-level snapshots 215, and each second-level snapshot 215 may include a respective set of first-level snapshots 210. For example, fourth-level snapshot 225-a-3 may include a set of third-level snapshots 220-c (e.g., monthly snapshots), and a third-level snapshot 220-c-n of the set of third-level snapshots 220-c may include a set of second-level snapshots 215-c (e.g., weekly snapshots). The second-level snapshot 215-c may include a set of first-level snapshots 210-g (e.g., daily snapshots).

In some examples, the DMS may delete (e.g., garbage collect) a third-level snapshot 220 after generating a fourth-level snapshot 225 in accordance with the third retention policy (e.g., monthlies may be retained for 1 year). For example, the DMS may delete the set of third-level snapshots 220-a after all of the third-level snapshots 220-a are expired (e.g., after generating the fourth-level snapshot 225-a-2).

In some examples, the DMS may generate a second base snapshot. For example, the DMS may generate the second base snapshot based on a quantity of differential data between the fourth-level snapshot 225-a-3 and the base snapshot 205 satisfying a threshold (e.g., if a size of the incremental fourth-level snapshot 225-a-3 exceeds a size threshold, is similar to a size of a full snapshot). Additionally, or alternatively, the DMS may generate the second base snapshot in accordance with a retention policy of the hierarchal snapshot diagram (e.g., based on a threshold duration from generation of the base snapshot 205). The DMS may generate a second hierarchal snapshot diagram using the second base snapshot.

In some examples, by hierarchically storing snapshots in accordance with their respective snapshot frequencies, the techniques described herein may enable the DMS to perform a recovery operation for the target computing object with relatively lower latency compared to other chain-based systems. For example, the latency may be reduced due to the DMS traversing through fewer snapshots through the hierarchal snapshot levels to perform the recovery operation as opposed to other systems that may traverse through a relatively longer snapshot chain.

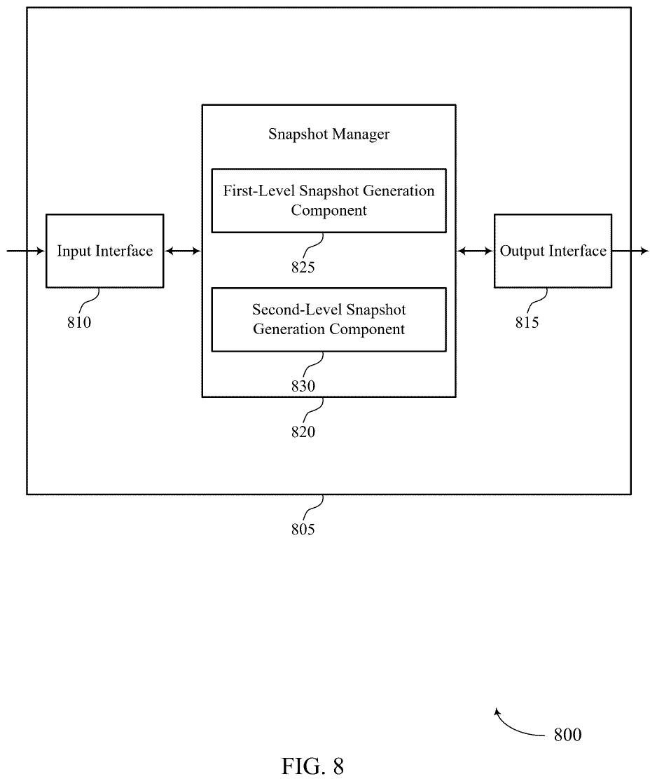

FIG. 8 shows a block diagram 800 of a system 805 that supports hierarchal snapshot retention storage in accordance with aspects of the present disclosure. In some examples, the system 805 may be an example of aspects of one or more components described with reference to FIG. 1, such as a DMS 110. The system 805 may include an input interface 810, an output interface 815, and a snapshot manager 820. The system 805 may also include one or more processors. Each of these components may be in communication with one another (e.g., via one or more buses, communications links, communications interfaces, or any combination thereof).

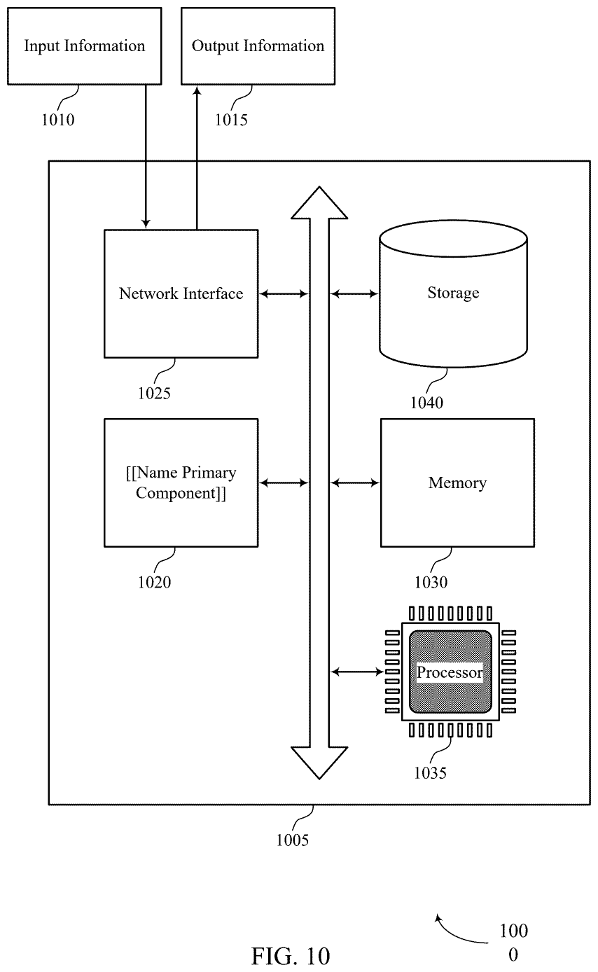

The input interface 810 may manage input signaling for the system 805. For example, the input interface 810 may receive input signaling (e.g., messages, packets, data, instructions, commands, or any other form of encoded information) from other systems or devices. The input interface 810 may send signaling corresponding to (e.g., representative of or otherwise based on) such input signaling to other components of the system 805 for processing. For example, the input interface 810 may transmit such corresponding signaling to the snapshot manager 820 to support hierarchal snapshot retention storage. In some cases, the input interface 810 may be a component of a network interface 1025 as described with reference to FIG. 10.

The output interface 815 may manage output signaling for the system 805. For example, the output interface 815 may receive signaling from other components of the system 805, such as the snapshot manager 820, and may transmit such output signaling corresponding to (e.g., representative of or otherwise based on) such signaling to other systems or devices. In some cases, the output interface 815 may be a component of a network interface 1025 as described with reference to FIG. 10.

For example, the snapshot manager 820 may include a first-level snapshot generation component 825 a second-level snapshot generation component 830, or any combination thereof. In some examples, the snapshot manager 820, or various components thereof, may be configured to perform various operations (e.g., receiving, monitoring, transmitting) using or otherwise in cooperation with the input interface 810, the output interface 815, or both. For example, the snapshot manager 820 may receive information from the input interface 810, send information to the output interface 815, or be integrated in combination with the input interface 810, the output interface 815, or both to receive information, transmit information, or perform various other operations as described herein.

The first-level snapshot generation component 825 may be configured as or otherwise support a means for generating a first set of first-level incremental snapshots of a target computing object in accordance with a first snapshot frequency, where one first-level incremental snapshot in the first set of first-level incremental snapshots includes differential data relative to a base snapshot of the target computing object, and where each other first-level incremental snapshot in the first set of first-level incremental snapshots includes differential data relative to a respective previous first-level incremental snapshot in the first set of first-level incremental snapshots. The second-level snapshot generation component 830 may be configured as or otherwise support a means for generating a first second-level incremental snapshot of the target computing object in accordance with a second snapshot frequency, where the second snapshot frequency is lower than the first snapshot frequency, and where the first second-level incremental snapshot includes differential data relative to the base snapshot. The first-level snapshot generation component 825 may be configured as or otherwise support a means for generating a second set of first-level incremental snapshots of the target computing object in accordance with the first snapshot frequency, where one first-level incremental snapshot in the second set of first-level incremental snapshots includes differential data relative to the first second-level incremental snapshot, and where each other first-level incremental snapshot in the second set of first-level incremental snapshots includes differential data relative to a respective previous first-level incremental snapshot in the second set of first-level incremental snapshots.

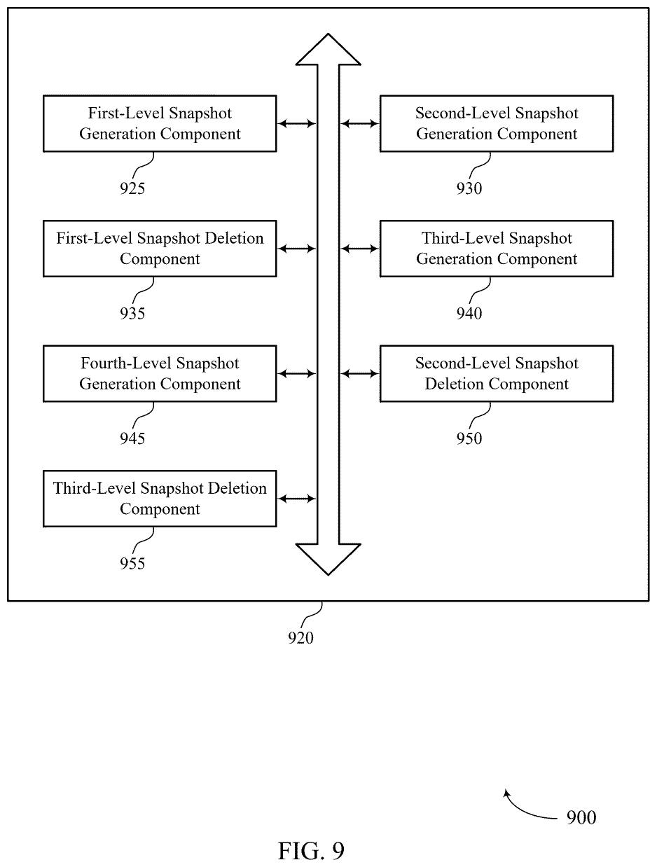

FIG. 9 shows a block diagram 900 of a snapshot manager 920 that supports hierarchal snapshot retention storage in accordance with aspects of the present disclosure. The snapshot manager 920 may be an example of aspects of a snapshot manager or a snapshot manager 820, or both, as described herein. The snapshot manager 920, or various components thereof, may be an example of means for performing (e.g., to cause the snapshot manager 920 to perform) various aspects of hierarchal snapshot retention storage as described herein. For example, the snapshot manager 920 may include a first-level snapshot generation component 925, a second-level snapshot generation component 930, a first-level snapshot deletion component 935, a third-level snapshot generation component 940, a fourth-level snapshot generation component 945, a second-level snapshot deletion component 950, a third-level snapshot deletion component 955, or any combination thereof. Each of these components, or components of subcomponents thereof (e.g., one or more processors, one or more memories), may communicate, directly or indirectly, with one another (e.g., via one or more buses, communications links, communications interfaces, or any combination thereof).

The first-level snapshot generation component 925 may be configured as or otherwise support a means for generating a first set of first-level incremental snapshots of a target computing object in accordance with a first snapshot frequency, where one first-level incremental snapshot in the first set of first-level incremental snapshots includes differential data relative to a base snapshot of the target computing object, and where each other first-level incremental snapshot in the first set of first-level incremental snapshots includes differential data relative to a respective previous first-level incremental snapshot in the first set of first-level incremental snapshots. The second-level snapshot generation component 930 may be configured as or otherwise support a means for generating a first second-level incremental snapshot of the target computing object in accordance with a second snapshot frequency, where the second snapshot frequency is lower than the first snapshot frequency, and where the first second-level incremental snapshot includes differential data relative to the base snapshot. In some examples, the first-level snapshot generation component 925 may be configured as or otherwise support a means for generating a second set of first-level incremental snapshots of the target computing object in accordance with the first snapshot frequency, where one first-level incremental snapshot in the second set of first-level incremental snapshots includes differential data relative to the first second-level incremental snapshot, and where each other first-level incremental snapshot in the second set of first-level incremental snapshots includes differential data relative to a respective previous first-level incremental snapshot in the second set of first-level incremental snapshots.

In some examples, the second-level snapshot generation component 930 may be configured as or otherwise support a means for generating a second second-level incremental snapshot of the target computing object in accordance with the second snapshot frequency, where the second second-level incremental snapshot includes differential data relative to the first second-level incremental snapshot. In some examples, the first-level snapshot deletion component 935 may be configured as or otherwise support a means for deleting the first set of first-level incremental snapshots after generating the first second-level incremental snapshot and in accordance with a first retention policy associated with the first snapshot frequency.

In some examples, the third-level snapshot generation component 940 may be configured as or otherwise support a means for generating a first third-level incremental snapshot of the target computing object in accordance with a third snapshot frequency, where the third snapshot frequency is lower than the second snapshot frequency, and where the first third-level incremental snapshot includes differential data relative to the base snapshot. In some examples, the second-level snapshot deletion component 950 may be configured as or otherwise support a means for deleting the first second-level incremental snapshot after generating the first third-level incremental snapshot and in accordance with a second retention policy associated with the second snapshot frequency.

In some examples, the first-level snapshot generation component 925 may be configured as or otherwise support a means for generating a third set of first-level incremental snapshots of a target computing object in accordance with the first snapshot frequency, where one first-level incremental snapshot in the third set of first-level incremental snapshots includes differential data relative to the first third-level incremental snapshot of the target computing object, and where each other first-level incremental snapshot in the third set of first-level incremental snapshots includes differential data relative to a respective previous first-level incremental snapshot in the third set of first-level incremental snapshots.

In some examples, the second-level snapshot generation component 930 may be configured as or otherwise support a means for generating a third second-level incremental snapshot of the target computing object in accordance with the second snapshot frequency, where the third second-level incremental snapshot includes differential data relative to the first third-level incremental snapshot. In some examples, the third-level snapshot generation component 940 may be configured as or otherwise support a means for generating a second third-level incremental snapshot of the target computing object in accordance with the third snapshot frequency, where the second third-level incremental snapshot includes differential data relative to the first third-level incremental snapshot.

In some examples, the fourth-level snapshot generation component 945 may be configured as or otherwise support a means for generating a first fourth-level incremental snapshot of the target computing object in accordance with a fourth snapshot frequency, where the fourth snapshot frequency is lower than a third snapshot frequency associated with third-level incremental snapshots of the target computing object, the third snapshot frequency lower than the second snapshot frequency, and where the first fourth-level incremental snapshot includes differential data relative to the base snapshot. In some examples, the third-level snapshot deletion component 955 may be configured as or otherwise support a means for deleting a first third-level incremental snapshot of the target computing object after generating the first fourth-level incremental snapshot and in accordance with a third retention policy associated with the third snapshot frequency, where the first third-level incremental snapshot includes differential data relative to the base snapshot.

In some examples, the first set of first-level incremental snapshots includes a first set of daily snapshots, the first second-level incremental snapshot includes a first weekly snapshot, the first third-level incremental snapshot includes a first monthly snapshot, and the first fourth-level incremental snapshot includes a yearly snapshot.

In some examples, the first-level snapshot generation component 925 may be configured as or otherwise support a means for generating a fourth set of first-level incremental snapshots of the target computing object in accordance with the first snapshot frequency, where one first-level incremental snapshot in the fourth set of first-level incremental snapshots includes differential data relative to the first fourth-level incremental snapshot of the target computing object, and where each other first-level incremental snapshot in the fourth set of first-level incremental snapshots includes differential data relative to a respective previous first-level incremental snapshot in the fourth set of first-level incremental snapshots.

In some examples, the second-level snapshot generation component 930 may be configured as or otherwise support a means for generating a fourth second-level incremental snapshot of the target computing object in accordance with the second snapshot frequency, where the fourth second-level incremental snapshot includes differential data relative to the first fourth-level incremental snapshot. In some examples, the third-level snapshot generation component 940 may be configured as or otherwise support a means for generating a third third-level incremental snapshot of the target computing object in accordance with the third snapshot frequency, where the third third-level incremental snapshot includes differential data relative to the first fourth-level incremental snapshot.

In some examples, the fourth-level snapshot generation component 945 may be configured as or otherwise support a means for generating a second fourth-level incremental snapshot of the target computing object in accordance with the fourth snapshot frequency, where the second fourth-level incremental snapshot includes differential data relative to the first fourth-level incremental snapshot. In some examples, the first set of first-level incremental snapshots includes a first set of daily snapshots, the first second-level incremental snapshot includes a first weekly snapshot, and the second set of first-level incremental snapshots includes a second set of daily snapshots.

It is to be understood that although four levels of snapshots and associated components are discussed with reference the example of FIG. 9, other examples in accordance with the present disclosure may include any quantity of levels of snapshots and associated components.

FIG. 10 shows a block diagram 1000 of a system 1005 that supports hierarchal snapshot retention storage in accordance with aspects of the present disclosure. The system 1005 may be an example of or include components of a system 805 as described herein. The system 1005 may include components for data management, including components such as a snapshot manager 1020, an input information 1010, an output information 1015, a network interface 1025, at least one memory 1030, at least one processor 1035, and a storage 1040. These components may be in electronic communication or otherwise coupled with each other (e.g., operatively, communicatively, functionally, electronically, electrically; via one or more buses, communications links, communications interfaces, or any combination thereof). Additionally, the components of the system 1005 may include corresponding physical components or may be implemented as corresponding virtual components (e.g., components of one or more virtual machines). In some examples, the system 1005 may be an example of aspects of one or more components described with reference to FIG. 1, such as a DMS 110.

The network interface 1025 may enable the system 1005 to exchange information (e.g., input information 1010, output information 1015, or both) with other systems or devices (not shown). For example, the network interface 1025 may enable the system 1005 to connect to a network (e.g., a network 120 as described herein). The network interface 1025 may include one or more wireless network interfaces, one or more wired network interfaces, or any combination thereof. In some examples, the network interface 1025 may be an example of may be an example of aspects of one or more components described with reference to FIG. 1, such as one or more network interfaces 165.

Memory 1030 may include RAM, ROM, or both. The memory 1030 may store computer-readable, computer-executable software including instructions that, when executed, cause the processor 1035 to perform various functions described herein. In some cases, the memory 1030 may contain, among other things, a basic input/output system (BIOS), which may control basic hardware or software operation such as the interaction with peripheral components or devices. In some cases, the memory 1030 may be an example of aspects of one or more components described with reference to FIG. 1, such as one or more memories 175.

The processor 1035 may include an intelligent hardware device, (e.g., a general-purpose processor, a DSP, a CPU, a microcontroller, an ASIC, a field programmable gate array (FPGA), a programmable logic device, a discrete gate or transistor logic component, a discrete hardware component, or any combination thereof). The processor 1035 may be configured to execute computer-readable instructions stored in a memory 1030 to perform various functions (e.g., functions or tasks supporting hierarchal snapshot retention storage). Though a single processor 1035 is depicted in the example of FIG. 10, it is to be understood that the system 1005 may include any quantity of one or more of processors 1035 and that a group of processors 1035 may collectively perform one or more functions ascribed herein to a processor, such as the processor 1035. In some cases, the processor 1035 may be an example of aspects of one or more components described with reference to FIG. 1, such as one or more processors 170.

Storage 1040 may be configured to store data that is generated, processed, stored, or otherwise used by the system 1005. In some cases, the storage 1040 may include one or more HDDs, one or more SDDs, or both. In some examples, the storage 1040 may be an example of a single database, a distributed database, multiple distributed databases, a data store, a data lake, or an emergency backup database. In some examples, the storage 1040 may be an example of one or more components described with reference to FIG. 1, such as one or more network disks 180.

For example, the snapshot manager 1020 may be configured as or otherwise support a means for generating a first set of first-level incremental snapshots of a target computing object in accordance with a first snapshot frequency, where one first-level incremental snapshot in the first set of first-level incremental snapshots includes differential data relative to a base snapshot of the target computing object, and where each other first-level incremental snapshot in the first set of first-level incremental snapshots includes differential data relative to a respective previous first-level incremental snapshot in the first set of first-level incremental snapshots. The snapshot manager 1020 may be configured as or otherwise support a means for generating a first second-level incremental snapshot of the target computing object in accordance with a second snapshot frequency, where the second snapshot frequency is lower than the first snapshot frequency, and where the first second-level incremental snapshot includes differential data relative to the base snapshot. The snapshot manager 1020 may be configured as or otherwise support a means for generating a second set of first-level incremental snapshots of the target computing object in accordance with the first snapshot frequency, where one first-level incremental snapshot in the second set of first-level incremental snapshots includes differential data relative to the first second-level incremental snapshot, and where each other first-level incremental snapshot in the second set of first-level incremental snapshots includes differential data relative to a respective previous first-level incremental snapshot in the second set of first-level incremental snapshots.

By including or configuring the snapshot manager 1020 in accordance with examples as described herein, the system 1005 may support techniques for hierarchal snapshot retention storage, which may provide one or more benefits such as, for example, reduced latency, improved user experience, more efficient utilization of computing resources, network resources or both, and improved scalability, among other possibilities.

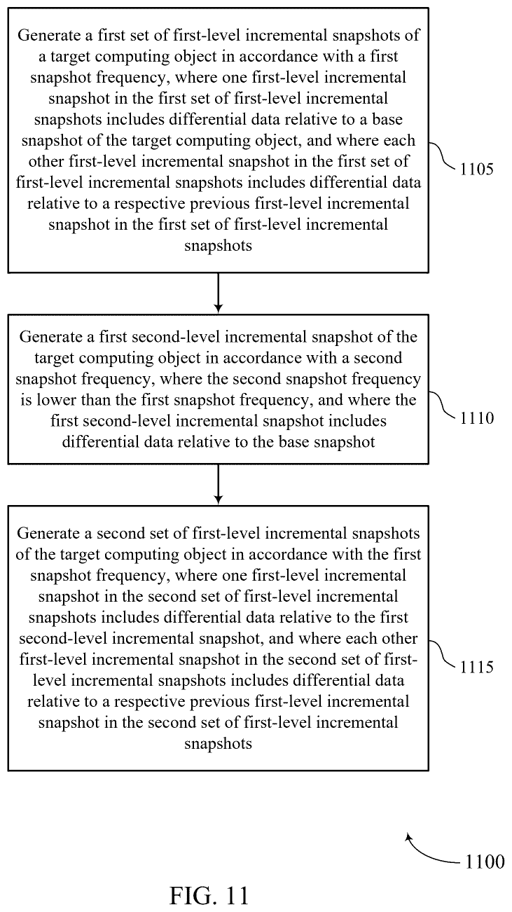

FIG. 11 shows a flowchart illustrating a method 1100 that supports hierarchal snapshot retention storage in accordance with aspects of the present disclosure. The operations of the method 1100 may be implemented by a DMS or its components as described herein. For example, the operations of the method 1100 may be performed by a DMS as described with reference to FIGS. 1 through 10. In some examples, a DMS may execute a set of instructions to control the functional elements of the DMS to perform the described functions. Additionally, or alternatively, the DMS may perform aspects of the described functions using special-purpose hardware.

At 1105, the method may include generating a first set of first-level incremental snapshots of a target computing object in accordance with a first snapshot frequency, where one first-level incremental snapshot in the first set of first-level incremental snapshots includes differential data relative to a base snapshot of the target computing object, and where each other first-level incremental snapshot in the first set of first-level incremental snapshots includes differential data relative to a respective previous first-level incremental snapshot in the first set of first-level incremental snapshots. The operations of 1105 may be performed in accordance with examples as disclosed herein. In some examples, aspects of the operations of 1105 may be performed by a first-level snapshot generation component 925.

At 1110, the method may include generating a first second-level incremental snapshot of the target computing object in accordance with a second snapshot frequency, where the second snapshot frequency is lower than the first snapshot frequency, and where the first second-level incremental snapshot includes differential data relative to the base snapshot. The operations of 1110 may be performed in accordance with examples as disclosed herein. In some examples, aspects of the operations of 1110 may be performed by a second-level snapshot generation component 930.

At 1115, the method may include generating a second set of first-level incremental snapshots of the target computing object in accordance with the first snapshot frequency, where one first-level incremental snapshot in the second set of first-level incremental snapshots includes differential data relative to the first second-level incremental snapshot, and where each other first-level incremental snapshot in the second set of first-level incremental snapshots includes differential data relative to a respective previous first-level incremental snapshot in the second set of first-level incremental snapshots. The operations of 1115 may be performed in accordance with examples as disclosed herein. In some examples, aspects of the operations of 1115 may be performed by a first-level snapshot generation component 925.

The following provides an overview of aspects of the present disclosure:

Aspect 1: A method, comprising: generating a first set of first-level incremental snapshots of a target computing object in accordance with a first snapshot frequency, wherein one first-level incremental snapshot in the first set of first-level incremental snapshots comprises differential data relative to a base snapshot of the target computing object, and wherein each other first-level incremental snapshot in the first set of first-level incremental snapshots comprises differential data relative to a respective previous first-level incremental snapshot in the first set of first-level incremental snapshots; generating a first second-level incremental snapshot of the target computing object in accordance with a second snapshot frequency, wherein the second snapshot frequency is lower than the first snapshot frequency, and wherein the first second-level incremental snapshot comprises differential data relative to the base snapshot; and generating a second set of first-level incremental snapshots of the target computing object in accordance with the first snapshot frequency, wherein one first-level incremental snapshot in the second set of first-level incremental snapshots comprises differential data relative to the first second-level incremental snapshot, and wherein each other first-level incremental snapshot in the second set of first-level incremental snapshots comprises differential data relative to a respective previous first-level incremental snapshot in the second set of first-level incremental snapshots.

Aspect 2: The method of aspect 1, further comprising: generating a second second-level incremental snapshot of the target computing object in accordance with the second snapshot frequency, wherein the second second-level incremental snapshot comprises differential data relative to the first second-level incremental snapshot.

Aspect 3: The method of any of aspects 1 through 2, further comprising: deleting the first set of first-level incremental snapshots after generating the first second-level incremental snapshot and in accordance with a first retention policy associated with the first snapshot frequency.

Aspect 4: The method of any of aspects 1 through 3, further comprising: generating a first third-level incremental snapshot of the target computing object in accordance with a third snapshot frequency, wherein the third snapshot frequency is lower than the second snapshot frequency, and wherein the first third-level incremental snapshot comprises differential data relative to the base snapshot.

Aspect 5: The method of aspect 4, further comprising: deleting the first second-level incremental snapshot after generating the first third-level incremental snapshot and in accordance with a second retention policy associated with the second snapshot frequency.

Aspect 6: The method of any of aspects 4 through 5, further comprising: generating a third set of first-level incremental snapshots of a target computing object in accordance with the first snapshot frequency, wherein one first-level incremental snapshot in the third set of first-level incremental snapshots comprises differential data relative to the first third-level incremental snapshot of the target computing object, and wherein each other first-level incremental snapshot in the third set of first-level incremental snapshots comprises differential data relative to a respective previous first-level incremental snapshot in the third set of first-level incremental snapshots.

Aspect 7: The method of aspect 6, further comprising: generating a third second-level incremental snapshot of the target computing object in accordance with the second snapshot frequency, wherein the third second-level incremental snapshot comprises differential data relative to the first third-level incremental snapshot.

Aspect 8: The method of any of aspects 4 through 7, further comprising: generating a second third-level incremental snapshot of the target computing object in accordance with the third snapshot frequency, wherein the second third-level incremental snapshot comprises differential data relative to the first third-level incremental snapshot.

Aspect 9: The method of any of aspects 1 through 8, further comprising: generating a first fourth-level incremental snapshot of the target computing object in accordance with a fourth snapshot frequency, wherein the fourth snapshot frequency is lower than a third snapshot frequency associated with third-level incremental snapshots of the target computing object, the third snapshot frequency lower than the second snapshot frequency, and wherein the first fourth-level incremental snapshot comprises differential data relative to the base snapshot.

Aspect 10: The method of aspect 9, further comprising: deleting a first third-level incremental snapshot of the target computing object after generating the first fourth-level incremental snapshot and in accordance with a third retention policy associated with the third snapshot frequency, wherein the first third-level incremental snapshot comprises differential data relative to the base snapshot.

Aspect 11: The method of aspect 10, wherein the first set of first-level incremental snapshots comprises a first set of daily snapshots, the first second-level incremental snapshot comprises a first weekly snapshot, the first third-level incremental snapshot comprises a first monthly snapshot, and the first fourth-level incremental snapshot comprises a yearly snapshot.

Aspect 12: The method of any of aspects 9 through 11, further comprising: generating a fourth set of first-level incremental snapshots of the target computing object in accordance with the first snapshot frequency, wherein one first-level incremental snapshot in the fourth set of first-level incremental snapshots comprises differential data relative to the first fourth-level incremental snapshot of the target computing object, and wherein each other first-level incremental snapshot in the fourth set of first-level incremental snapshots comprises differential data relative to a respective previous first-level incremental snapshot in the fourth set of first-level incremental snapshots.

Aspect 13: The method of any of aspects 9 through 12, further comprising: generating a fourth second-level incremental snapshot of the target computing object in accordance with the second snapshot frequency, wherein the fourth second-level incremental snapshot comprises differential data relative to the first fourth-level incremental snapshot.

Aspect 14: The method of any of aspects 9 through 13, further comprising: generating a third third-level incremental snapshot of the target computing object in accordance with the third snapshot frequency, wherein the third third-level incremental snapshot comprises differential data relative to the first fourth-level incremental snapshot.

Aspect 15: The method of any of aspects 9 through 14, further comprising: generating a second fourth-level incremental snapshot of the target computing object in accordance with the fourth snapshot frequency, wherein the second fourth-level incremental snapshot comprises differential data relative to the first fourth-level incremental snapshot.

Aspect 16: The method of any of aspects 1 through 15, wherein the first set of first-level incremental snapshots comprises a first set of daily snapshots, the first second-level incremental snapshot comprises a first weekly snapshot, and the second set of first-level incremental snapshots comprises a second set of daily snapshots.

Aspect 17: An apparatus comprising one or more memories storing processor-executable code, and one or more processors coupled with the one or more memories and individually or collectively operable to execute the code to cause the apparatus to perform a method of any of aspects 1 through 16.

Aspect 18: An apparatus comprising at least one means for performing a method of any of aspects 1 through 16.

Aspect 19: A non-transitory computer-readable medium storing code the code comprising instructions executable by one or more processors to perform a method of any of aspects 1 through 16.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Further, a system as used herein may be a collection of devices, a single device, or aspects within a single device.

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, EEPROM) compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, “a component” having characteristics or performing functions may refer to “at least one of one or more components” having a particular characteristic or performing a particular function. Subsequent reference to a component introduced with the article “a” using the terms “the” or “said” refers to any or all of the one or more components. For example, a component introduced with the article “a” shall be understood to mean “one or more components,” and referring to “the component” subsequently in the claims shall be understood to be equivalent to referring to “at least one of the one or more components.”

Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A method, comprising:
storing, to a storage environment, a first set of first-level incremental snapshots of a target computing object in accordance with a first snapshot frequency, wherein one first-level incremental snapshot in the first set of first-level incremental snapshots comprises differential data relative to a base snapshot of the target computing object, and wherein each other first-level incremental snapshot in the first set of first-level incremental snapshots comprises differential data relative to a respective previous first-level incremental snapshot in the first set of first-level incremental snapshots;
storing, to the storage environment, a first second-level incremental snapshot of the target computing object in accordance with a second snapshot frequency, wherein the second snapshot frequency is lower than the first snapshot frequency, and wherein the first second-level incremental snapshot comprises differential data relative to the base snapshot; and
storing, to the storage environment, a second set of first-level incremental snapshots of the target computing object in accordance with the first snapshot frequency, wherein one first-level incremental snapshot in the second set of first-level incremental snapshots comprises differential data relative to the first second-level incremental snapshot, and wherein each other first-level incremental snapshot in the second set of first-level incremental snapshots comprises differential data relative to a respective previous first-level incremental snapshot in the second set of first-level incremental snapshots.

2. The method of claim 1, further comprising:
storing, to the storage environment, a second second-level incremental snapshot of the target computing object in accordance with the second snapshot frequency, wherein the second second-level incremental snapshot comprises differential data relative to the first second-level incremental snapshot.

3. The method of claim 1, further comprising:
deleting the first set of first-level incremental snapshots after storing the first second-level incremental snapshot and in accordance with a first retention policy associated with the first snapshot frequency.

4. The method of claim 1, further comprising:
storing, to the storage environment, a first third-level incremental snapshot of the target computing object in accordance with a third snapshot frequency, wherein the third snapshot frequency is lower than the second snapshot frequency, and wherein the first third-level incremental snapshot comprises differential data relative to the base snapshot.

5. The method of claim 4, further comprising:
deleting the first second-level incremental snapshot after storing the first third-level incremental snapshot and in accordance with a second retention policy associated with the second snapshot frequency.

6. The method of claim 4, further comprising:
storing, to the storage environment, a third set of first-level incremental snapshots of a target computing object in accordance with the first snapshot frequency, wherein one first-level incremental snapshot in the third set of first-level incremental snapshots comprises differential data relative to the first third-level incremental snapshot of the target computing object, and wherein each other first-level incremental snapshot in the third set of first-level incremental snapshots comprises differential data relative to a respective previous first-level incremental snapshot in the third set of first-level incremental snapshots.

7. The method of claim 6, further comprising:
storing, to the storage environment, a third second-level incremental snapshot of the target computing object in accordance with the second snapshot frequency, wherein the third second-level incremental snapshot comprises differential data relative to the first third-level incremental snapshot.

8. The method of claim 4, further comprising:
storing, to the storage environment, a second third-level incremental snapshot of the target computing object in accordance with the third snapshot frequency, wherein the second third-level incremental snapshot comprises differential data relative to the first third-level incremental snapshot.

9. The method of claim 1, further comprising:
storing, to the storage environment, a first fourth-level incremental snapshot of the target computing object in accordance with a fourth snapshot frequency, wherein the fourth snapshot frequency is lower than a third snapshot frequency associated with third-level incremental snapshots of the target computing object, the third snapshot frequency lower than the second snapshot frequency, and wherein the first fourth-level incremental snapshot comprises differential data relative to the base snapshot.

10. The method of claim 9, further comprising:
deleting a first third-level incremental snapshot of the target computing object after storing the first fourth-level incremental snapshot and in accordance with a third retention policy associated with the third snapshot frequency, wherein the first third-level incremental snapshot comprises differential data relative to the base snapshot.

11. The method of claim 10, wherein the first set of first-level incremental snapshots comprises a first set of daily snapshots, the first second-level incremental snapshot comprises a first weekly snapshot, the first third-level incremental snapshot comprises a first monthly snapshot, and the first fourth-level incremental snapshot comprises a yearly snapshot.

12. The method of claim 9, further comprising:
storing, to the storage environment, a fourth set of first-level incremental snapshots of the target computing object in accordance with the first snapshot frequency, wherein one first-level incremental snapshot in the fourth set of first-level incremental snapshots comprises differential data relative to the first fourth-level incremental snapshot of the target computing object, and wherein each other first-level incremental snapshot in the fourth set of first-level incremental snapshots comprises differential data relative to a respective previous first-level incremental snapshot in the fourth set of first-level incremental snapshots.

13. The method of claim 9, further comprising:
storing, to the storage environment, a fourth second-level incremental snapshot of the target computing object in accordance with the second snapshot frequency, wherein the fourth second-level incremental snapshot comprises differential data relative to the first fourth-level incremental snapshot.

14. The method of claim 9, further comprising:
storing, to the storage environment, a third third-level incremental snapshot of the target computing object in accordance with the third snapshot frequency, wherein the third third-level incremental snapshot comprises differential data relative to the first fourth-level incremental snapshot.

15. The method of claim 9, further comprising:
storing, to the storage environment, a second fourth-level incremental snapshot of the target computing object in accordance with the fourth snapshot frequency, wherein the second fourth-level incremental snapshot comprises differential data relative to the first fourth-level incremental snapshot.

16. The method of claim 1, wherein the first set of first-level incremental snapshots comprises a first set of daily snapshots, the first second-level incremental snapshot comprises a first weekly snapshot, and the second set of first-level incremental snapshots comprises a second set of daily snapshots.

17. An apparatus, comprising:
one or more memories storing processor-executable code; and
one or more processors coupled with the one or more memories and individually or collectively operable to execute the code to cause the apparatus to:
store, to a storage environment, a first set of first-level incremental snapshots of a target computing object in accordance with a first snapshot frequency, wherein one first-level incremental snapshot in the first set of first-level incremental snapshots comprises differential data relative to a base snapshot of the target computing object, and wherein each other first-level incremental snapshot in the first set of first-level incremental snapshots comprises differential data relative to a respective previous first-level incremental snapshot in the first set of first-level incremental snapshots;
store, to the storage environment, a first second-level incremental snapshot of the target computing object in accordance with a second snapshot frequency, wherein the second snapshot frequency is lower than the first snapshot frequency, and wherein the first second-level incremental snapshot comprises differential data relative to the base snapshot; and
store, to the storage environment, a second set of first-level incremental snapshots of the target computing object in accordance with the first snapshot frequency, wherein one first-level incremental snapshot in the second set of first-level incremental snapshots comprises differential data relative to the first second-level incremental snapshot, and wherein each other first-level incremental snapshot in the second set of first-level incremental snapshots comprises differential data relative to a respective previous first-level incremental snapshot in the second set of first-level incremental snapshots.

18. The apparatus of claim 17, wherein the one or more processors are individually or collectively further operable to execute the code to cause the apparatus to:
delete the first set of first-level incremental snapshots after storing the first second-level incremental snapshot and in accordance with a first retention policy associated with the first snapshot frequency.

19. The apparatus of claim 17, wherein the one or more processors are individually or collectively further operable to execute the code to cause the apparatus to:
store, to the storage environment, a first third-level incremental snapshot of the target computing object in accordance with a third snapshot frequency, wherein the third snapshot frequency is lower than the second snapshot frequency, and wherein the first third-level incremental snapshot comprises differential data relative to the base snapshot.

20. A non-transitory computer-readable medium storing code, the code comprising instructions executable by one or more processors to:
store, to a storage environment, a first set of first-level incremental snapshots of a target computing object in accordance with a first snapshot frequency, wherein one first-level incremental snapshot in the first set of first-level incremental snapshots comprises differential data relative to a base snapshot of the target computing object, and wherein each other first-level incremental snapshot in the first set of first-level incremental snapshots comprises differential data relative to a respective previous first-level incremental snapshot in the first set of first-level incremental snapshots;
store, to the storage environment, a first second-level incremental snapshot of the target computing object in accordance with a second snapshot frequency, wherein the second snapshot frequency is lower than the first snapshot frequency, and wherein the first second-level incremental snapshot comprises differential data relative to the base snapshot; and
store, to the storage environment, a second set of first-level incremental snapshots of the target computing object in accordance with the first snapshot frequency, wherein one first-level incremental snapshot in the second set of first-level incremental snapshots comprises differential data relative to the first second-level incremental snapshot, and wherein each other first-level incremental snapshot in the second set of first-level incremental snapshots comprises differential data relative to a respective previous first-level incremental snapshot in the second set of first-level incremental snapshots.
